(19) United States
(12) Patent Application Publication
(10) Pub. No.: US 2006/0048534 A1
(43) Pub. Date: Mar. 9, 2006

(54) Self propelled food & beverage receptacle

(76) Inventor: Kevin Beal, Austin, TX (US)

Correspondence Address: ROBERT GREESON & DAVID HENRY, P.O. BOX 1470, WACO, TX, 76703, US

(21) Appl. No.: 11/103,919

(22) Filed: Apr. 12, 2005

Related U.S. Application Data
(63) Continuation-in-part of application No. 10/937,095, filed on Sep. 9, 2004.

(51) Int. Cl. B60H 1/32; F25D 3/08

(52) U.S. Cl. 62/239; 62/457.7

(57) ABSTRACT

A self propelled food and beverage receptacle apparatus where an insulated receptacle is in combination with a series of wheels, a precise steering mechanism, and a motor. The apparatus is capable of differential speed, precise steering, and breaking. Moreover, this self propelled receptacle is thought to be most beneficial in serving large crowds, where the stored cargo must be quickly and efficiently transported over relatively large distances where other transportation systems are not available. Particular embodiments are envisioned where a device operator may ride upon the insulated receptacle, or merely guide the receptacle with very little effort. The apparatus may be configured to have three or four wheels.

### CITATION TO PARENT APPLICATION(S)

This is a continuation-in-part with respect to U.S. patent application filed with U.S. Express Number EV 298571861 US, filed on Sep. 9, 2004, from which priority is claimed pursuant to 35 U.S.C. 120.

### BACKGROUND OF THE INVENTION

1. Field of the Invention

The present invention generally relates to an improved food and beverage receptacle. More specifically, the present invention relates to an improved food and beverage receptacle where the receptacle serves as insulated storage and may be propelled in motorized fashion. Particular embodiments are configured to have two, three, or four wheels and a very effective steering mechanism. As such, the device easily fulfills different tasks.

2. Background Information

Insulated food and beverage receptacles, commonly referred to as “ice chests,” are commonly carried or transported by simply hauling or dragging the chest. As such, these ice chests are subject to limitations that restrict their usefulness. Some “improved” ice chests have only, if at all, two wheels along their rear portion. Therefore, if any mechanical advantage is to be gained by its user, the user must continuously lift the front portion to effectively move the ice chest. One does not have to look far to see that such an ice chest would present undue burden when being transported over long distances or is relied upon to store relatively large quantities of food or beverage. Put simply, even those ice chests having a pair of wheels along their rear portion do not sufficiently alleviate the strain associated with the transport of such.

As mentioned, ice chests that have wheels are subject to undue limitations. For instance, as the load becomes heavier, and the receptacle more bulky, the usefulness of wheels alone decreases. These problems are exaggerated in the common situation where the ice chest must be rolled up a graded surface. Further, such limitations are even more apparent, and are often exaggerated, where the ice chest is relied upon to accommodate a large gathering of people. When extremely large quantities of ice, food, and beverages need be stored and transported during sporting events or similar gatherings of people, the effort required simply to move these quantities in manual fashion is unreasonably burdensome.

In view of these problems, what is needed is a device that functions as an ice chest, has both front and rear portion wheel support, and may be moved by some mechanical means (as opposed to manually). Through a novel combination of components, Applicant's invention obviates the most common problems associated with known ice chests. The present device is an ice chest integrated with a relatively small, but sufficiently powerful motor. Such configuration allows the ice chest to serve both as a transportation vehicle for a driver and as an ice chest. With particular designs a driver may ride on the device to a destination. Other designs allow for the driver to walk along the ice chest while directing it to a desired location, all the while guiding the device with very little effort. This is accomplished by virtue of a particularly effective steering mechanism. Finally, Applicant's invention allows for a particularly compact, lightweight device, where the device may be manually maneuvered with ease.

### SUMMARY OF THE INVENTION

The general purpose of the present invention, which will be described subsequently in greater detail, is to provide a self propelled food and beverage receptacle which has many of the advantages of such devices known in the art and many novel features that result in a new self propelled food and beverage receptacle which is not anticipated, rendered obvious, suggested, or even implied by any of the known devices, either alone or in any combination thereof.

In view of the above, Applicant's invention provides an insulated receptacle configured to mate with a mechanical propulsion means, such as a motor, and further configured to mate with a steering mechanism. Particular forms of the present invention, as will be further discussed, have support means such as seating pad, to allow a user to ride on top of the device during transport. Moreover, particular forms of Applicant's invention have two, three, or four wheels-configured to allow effective transport of the device.

In view of the foregoing and other related objectives, it is an object of the present invention to provide a food and beverage receptacle configured to transport a person.

It is another object of the present invention to provide a food and beverage receptacle configured to propel the receptacle by it's own motorization, with or without a driver.

It is another object of the present invention to relatively light weight provide an food and beverage receptacle.

It is another object of the present invention to provide a food and beverage receptacle to use a motorization source, such as a gasoline motor or electric motor.

It is another object of the present invention to provide a food and beverage receptacle having steering, braking, and throttle controls engaged with so the driver can control their related functions.

It is another object of the present invention to provide a food and beverage receptacle incorporating foot pegs which will allow the driver have a place to put their feet while riding.

It is another object of the present invention to provide a food and beverage receptacle incorporating foot pegs which are retractable or will fold up to make carrying the invention easier.

It is another object of the present invention to provide a food and beverage receptacle having one wheel.

It is another object of the present invention to provide a food and beverage receptacle having two wheels.

It is another object of the present invention to provide a food and beverage receptacle having three wheels.

It is another object of the present invention to provide a food and beverage receptacle having four wheels.

It is another object of the present invention to provide a food and beverage receptacle easily adapted to different sizes and types of motors.

It is another object of the present invention to provide a food and beverage receptacle having a steering mechanism allowing for precise steering.

It is another object of the present invention to provide a food and beverage receptacle conducive to easy, manual transport.

It is another object of the present invention to provide a food and beverage receptacle providing for accessories or upgrades to the device including a sidecar, a trailer, saddle bags, lights, a backrest, a cover, seat cushions, different design handlebars, different design foot pegs, white tires, off road suspension and four wheel drive.

It is another object of the present invention to provide a food and beverage receptacle having a telescoping handle to steer the invention.

It is yet another object of the present invention to provide a food and beverage receptacle having the steering handle pivot at the bottom so that the handle can be angled to make towing or pulling easier, in a single front wheel design.

Applicant's invention provides an ice chest integrated with a relatively small, but sufficiently powerful motor. Such configuration allows the ice chest to serve both as a transportation vehicle for a driver and as an ice chest. With particular designs a driver may ride on the device to a destination. Other designs allow for the driver to walk along the ice chest while directing it to a desired location, all the while guiding the device with very little effort. This is accomplished by virtue of a particularly effective steering mechanism. Finally, Applicant's invention allows for a particularly compact, lightweight device, where the device may be manually maneuvered with ease.

### BRIEF DESCRIPTION OF THE DRAWINGS

FIG. 1 is a perspective view the preferred embodiment of the present invention.

FIG. 2 is a side view of the preferred embodiment of the present invention.

FIG. 3 is another side view of the preferred embodiment of the present invention.

FIG. 4 is a top view of the preferred embodiment of the present invention.

FIG. 5 is a side plan view of the preferred embodiment of the present invention.

FIG. 6 is a perspective view of an alternative embodiment of the present invention.

FIG. 7 is yet another perspective view of an alternative embodiment of the present invention.

FIG. 8 is yet another perspective view of an alternative embodiment of the present invention.

FIG. 9 is a side plan view of an alternative preferred embodiment of the present invention.

FIG. 10 is a top view of the preferred embodiment of the present invention.

FIG. 11 is a side view of an alternative embodiment of the present invention having a four wheel design.

FIG. 12 is an exploded view of an alternative embodiment of the present invention having a four wheel design.

FIG. 13 is a perspective view of an alternative embodiment of the present invention having a four wheel design.

FIG. 14 is a front view of an alternative embodiment of the present invention having a four wheel design.

FIG. 15 is front and side view of a portion steering assembly of an alternative embodiment of the present invention.

FIG. 16 is a side view of an alternative embodiment of the present invention having a four wheel design.

FIG. 17 is a front interior view of an alternative embodiment of the present invention having a four wheel design.

### DETAILED DESCRIPTION OF THE PREFERRED EMBODIMENT

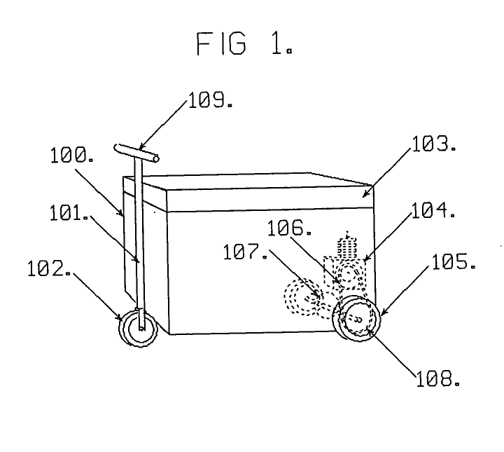

Referring generally to FIG. 1, the device of the present invention is generally referred to by the numeral 10. In FIG. 1 insulated receptacle 100 is shown. Receptacle 100, in the preferred embodiment may be generally configured to allow access either from the top or the bottom. Further, receptacle 100 is configured to receive and engage with motor means 104. The pivoting or removable lid is shown on top of receptacle 100 as 103. Receptacle 100 and other components are powered by motor 104 in combination with a drive mechanism. In the preferred embodiment, the drive mechanism is comprised of chain 106, which is used to power the drive sprocket 108, which turns the tire 105. Braking is provided by pressure to a rear disk 107. In the preferred embodiment, steering for the invention is through the front tire 102, as steering shaft 101 is turned by turning handle 109. Other useful embodiments are envisioned where lid 103 is configured to allow device 10 to be driven like an automobile, where the driver sits atop of lid 103.

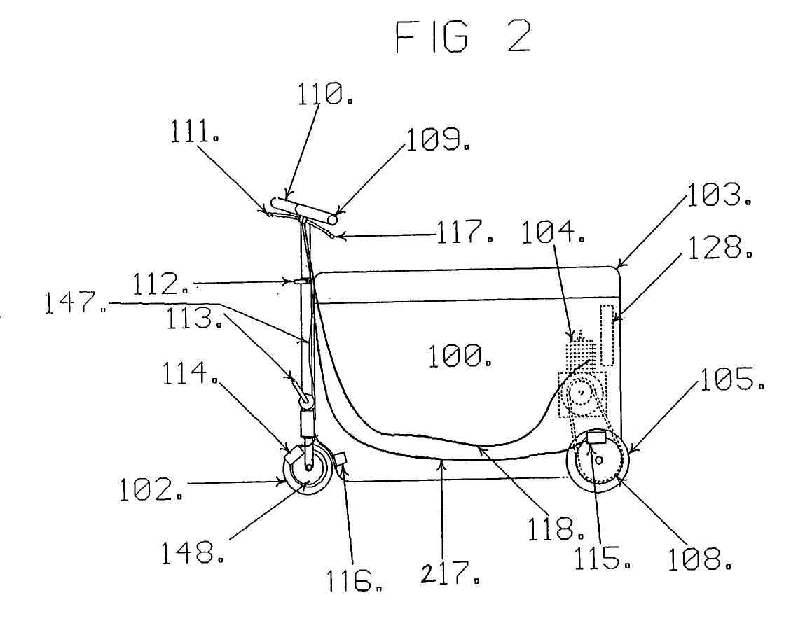

Referring primarily to FIG. 2 the throttle for the invention is controlled by the twisting of throttle tube 11. Tube 110 is mounted over turning handle 109, which is attached to cable 118, and extends to rear motor 104. Motor 104 then provides a regulated power supply to device 10. Again referring to FIG. 2, motor means 104 may be mounted along the rear of device 10, thereby providing direct power through chain 106 and rear sprocket 108, which turns tire 105.

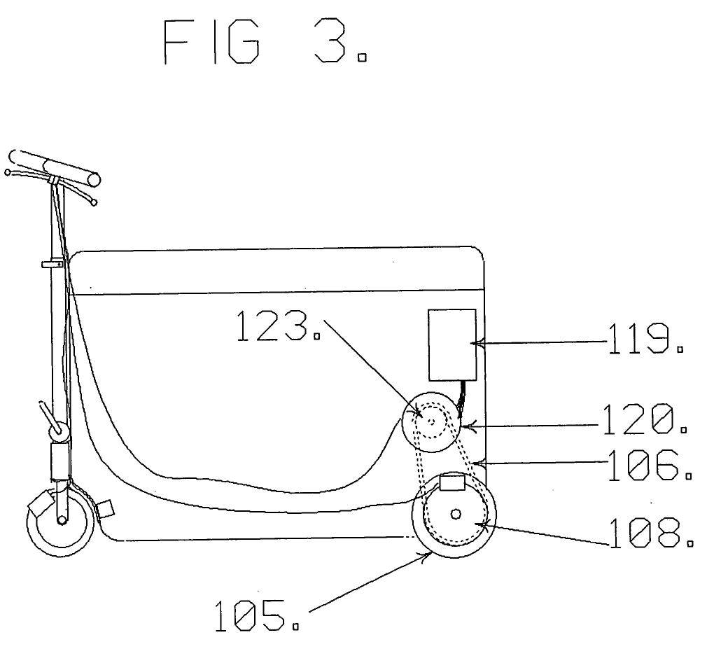

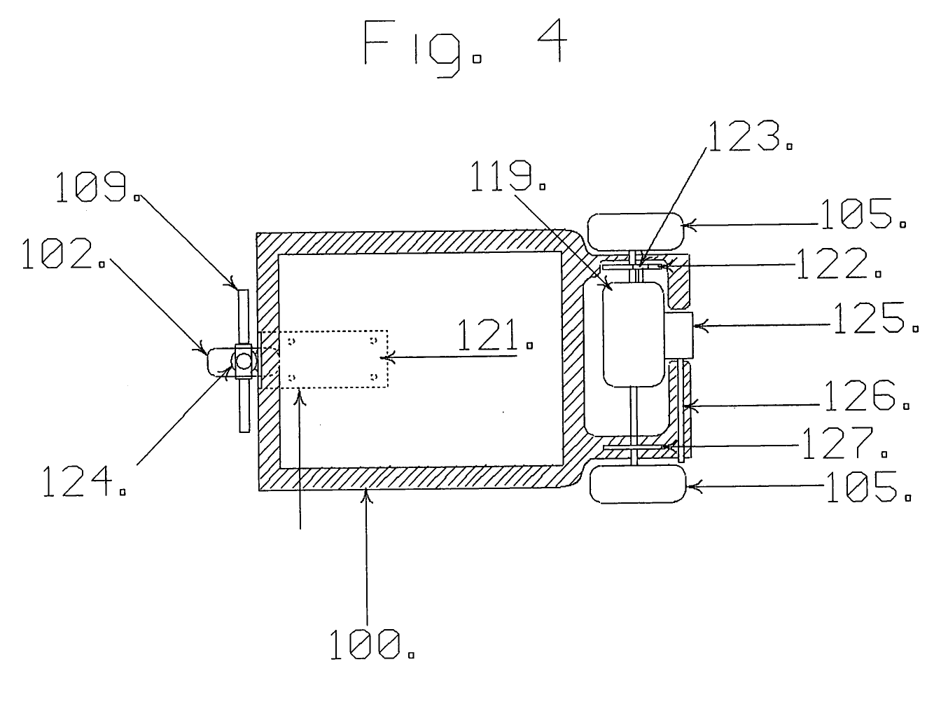

FIG. 3 shows the electric-powered embodiment of device 10, whereby an electric motor 120 is powered by battery 119. And, from FIG. 3 & FIG. 4, motor 120 drives sprocket 123, which in turn drives chain 106 to rear sprocket 122, which turns tire 105.

In the preferred embodiment, braking for device 10 is provided by the connection of one or more braking levers, 111 and 117, attached to front cable 147 and rear cable 217, respectively. Front cable 147 and rear cable 217 are connected to brake calipers 116 and 115 respectfully. The squeezing of levers 111 and 117 cause the calipers to close, providing pressure on the front disk 148 and the drive rear gear sprocket 108. Such action allows device 10 to be stopped.

FIG. 4 shows where the front steering mechanism is shown to be attached at collar 124. In the preferred embodiment, such attachment is achieved through welding or other similar attachment means to plate 121. Plate 121 is attached to receptacle 100 through screws or some other suitable attachment means, and is also internally made into body 100. Preferably, steering of device 10 is made by turning handle 109 whose shaft 101 runs through a typical bearing collar 124 to make turning permissible. FIG. 4 further shows intake port and exhaust port 126 for motor 125, which allows air to enter the motor from behind and allows the exhaust to exit the motor through tube 126. There is an additional optional brake plate 127 shown so that in the event it is not feasible to apply a caliper to drive sprocket 122 there are optional braking means. The motor drive sprocket 123 is also shown.

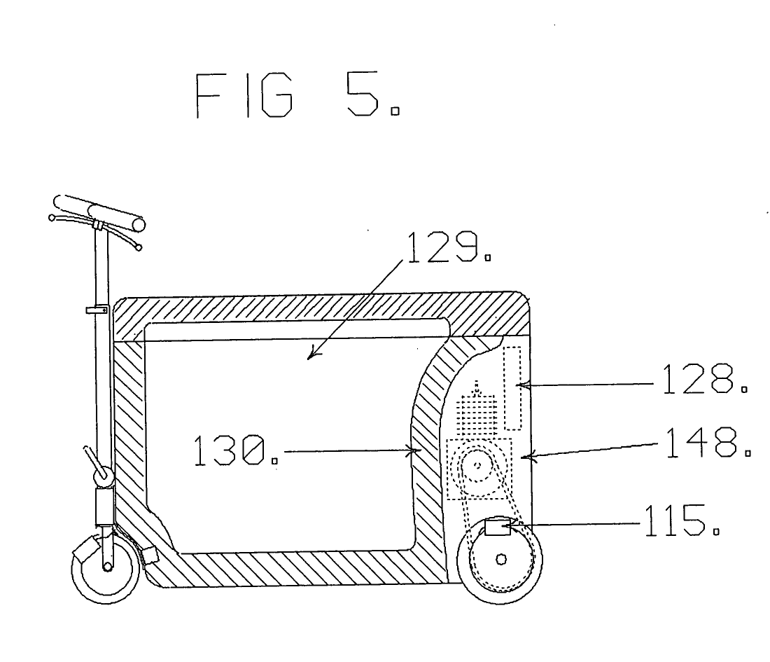

As best seen in FIG. 5 a particularly useful embodiment is envisioned where fuel tank 128 is also incorporated into the design for the gasoline-powered embodiment of device 10. In FIG. 5 a cross sectional view of device 10 is shown depicting the separation of motor compartment 148 from receptacle storage area 129 by barrier or division wall 130. The fuel tank 128 and rear brake caliper 115 are also shown.

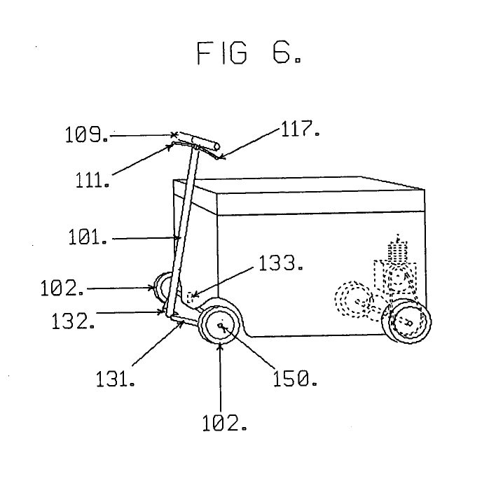

Referring now to FIG. 6 and in the alternative FIG. 4, one of the two braking systems (front/back) may be eliminated so that only one lever/caliper/cable assembly is required. Retractable footrest 113 allows the driver a place to rest their feet while riding.

Again referring to FIG. 6, an alternative steering mechanism is demonstrated where the standard mechanical means for most typical wagons is used. This configuration is comprised of a turning platform 131 which is attached to axle 150 and whose assembly pivots upon spindle 133. Turning of platform 131 is accomplished by the turning of the handle 109, whose shaft 101 transfers the turning to the platform 131. Both brake levers 111 and 117 are also shown.

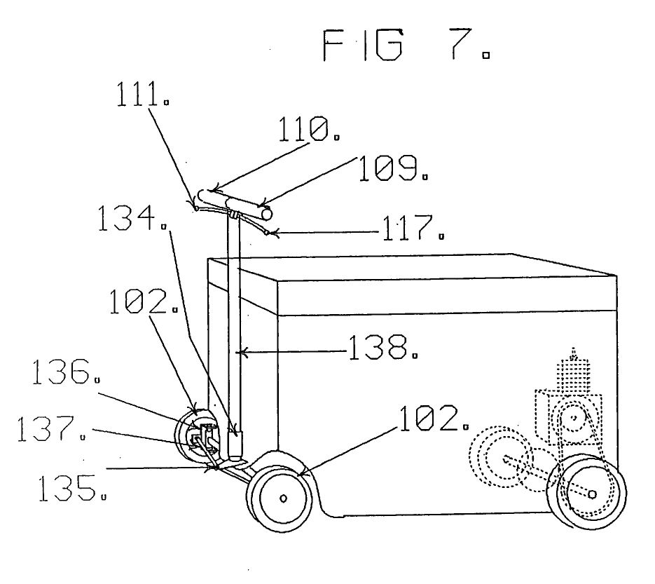

In FIG. 7 another alternative turning method is shown whereby a standard automotive type of steering application is utilized. In this embodiment, steering is accomplished by the turning of handle 109 which turns shaft 138 which transfers the turning force to pivot 135. The pivots on each respective wheel 136 are thereby turned by the tie rods 137 and wheel 102 turning is accomplished.

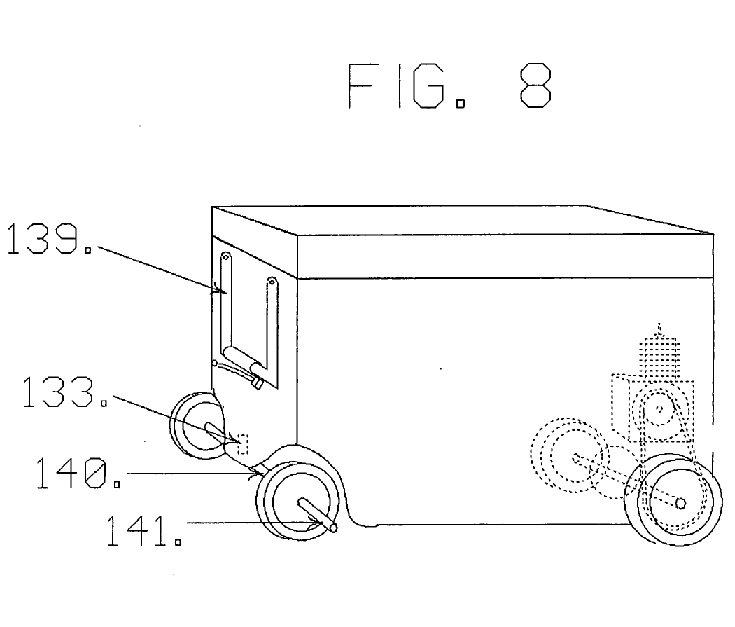

In FIG. 8 yet another turning method is accomplished by the simple pushing of the extended axle 141 by a drivers feet. The turning is provided, as differential pressure is applied to outer axle segment 141 by the driver and inner axle segment 140 turns upon pivot 133. This design also incorporates a simple handle design outfitted with the throttle and braking lever.

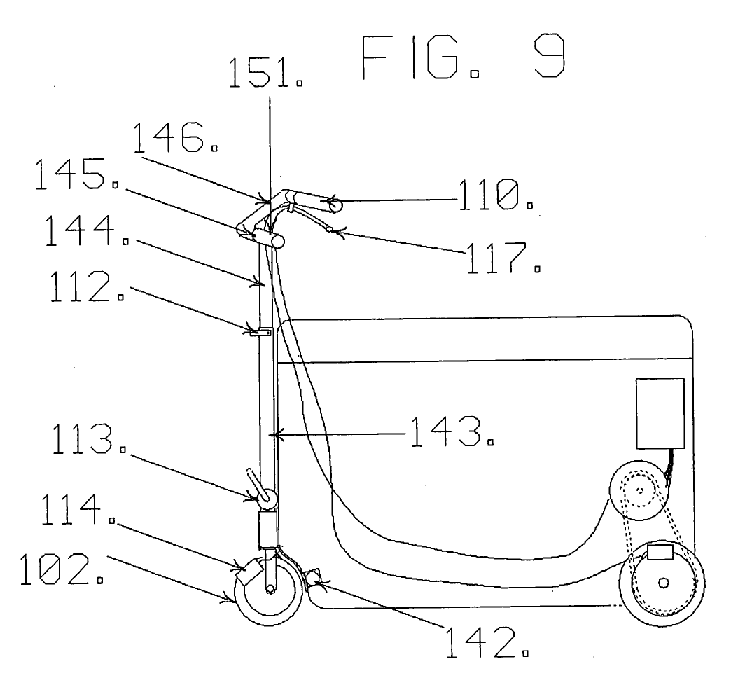

In FIG. 9 a more detailed, more complex steering application, used where lower steering tube shaft 143 is larger than the upper steering shaft 144 so that by loosening clamp 112 the steering tube can collapse into itself. This allows an operator to move the handle out of the way. The shaft assembly 144 and 112 can also be pivoted from its perpendicular position by the loosening of pivot clamp 113 and then the re-tightening of said clamp once the desired position is achieved. This design also incorporates a pivoting upper arm assembly 146 whose position can be changed by the suppression of a spring-loaded pin 145 whose new position is regulated by fixed holes in collar 151. This configuration also uses a single brake level 117 and a single twisting throttle assembly 110, fixed upon shaft 146. This configuration allows the operator the ability to use this extended handle 146 to pull the invention if so desired. Also shown is the collapsible foot peg 142 which is a tube inside of another tube to allow extension.

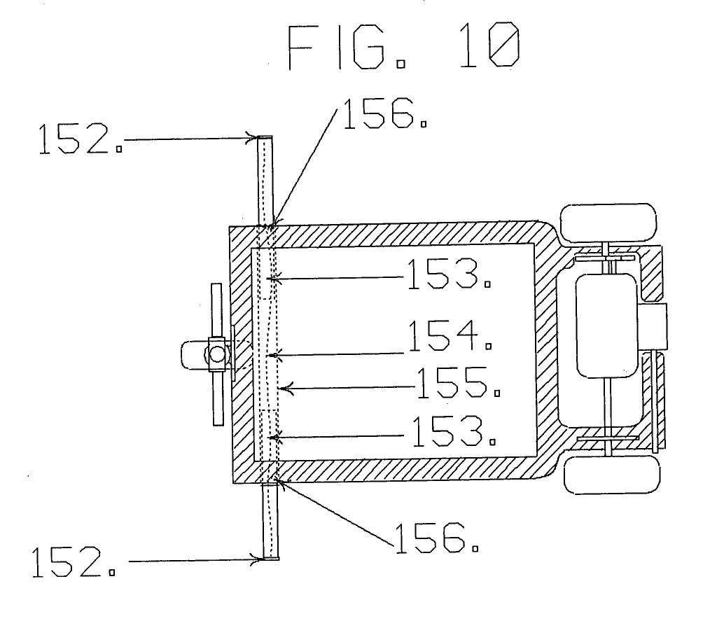

In FIG. 10 a detailed view of the foot peg assembly shown where each of the two-foot pegs 152 can be retracted into shaft 155 by the suppression of spring pin 156. The foot pegs 152 are spring loaded by the insertion of a elastic cord attached to each of the two pegs 152 which allows them to retract automatically once pin 156 is suppressed. It is also an alternate design of the invention to allow the foot pegs 152 to be folded up through a pivot point located approximately where pin 156 is located so that they are out of the way.

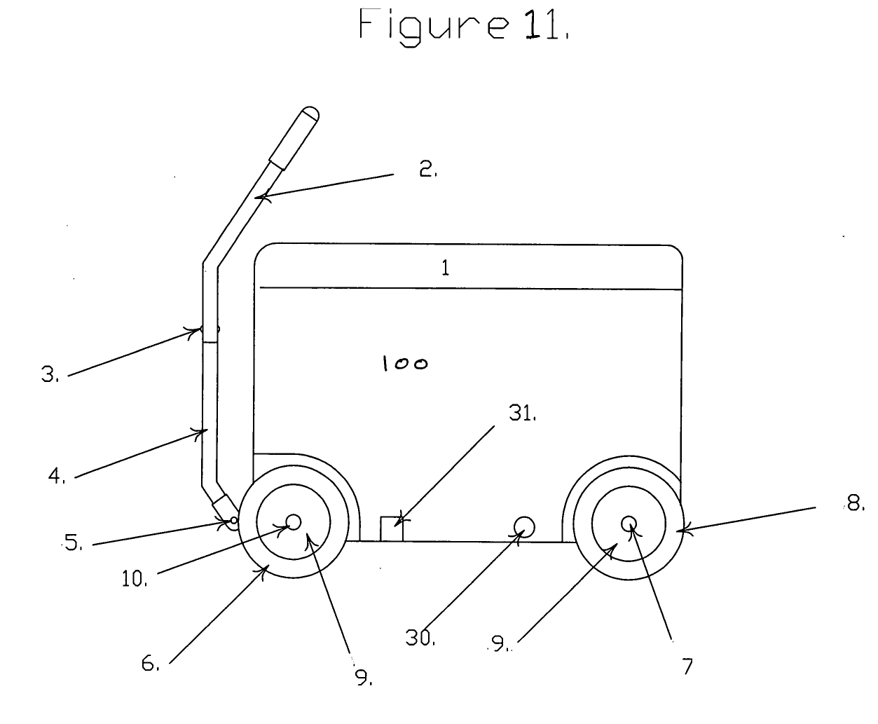

In FIG. 11, an alternative embodiment of the present invention is depicted where receptacle 100 has lid 1 resting atop thereof. This alternative embodiment is thought to be particularly beneficial as device 10 can be pulled as a wagon by a user grabbing top handle assembly 2, which is held together with bottom handle 4 by connector 3. The assembly formed by the combination of handle 2 and handle 4 can rotate about pivot point 5 between a top position (i.e., when at rest) and a lowered position (i.e., when being pulled). Handle 4 is secured about pivot point 5 with a bolt and nut combination, or some other attachment means as known in the art. Front tires 6 are secured about rims 9 where rims 9 rotate about front axle 10. In like fashion, rear tires 8 are secured about rims 9 where rims 9 rotate on rear axle 7. Finally, a rider may rest their feet on 31 extending from receptacle 100, and receptacle 100 may be drained at drain aperture 30.

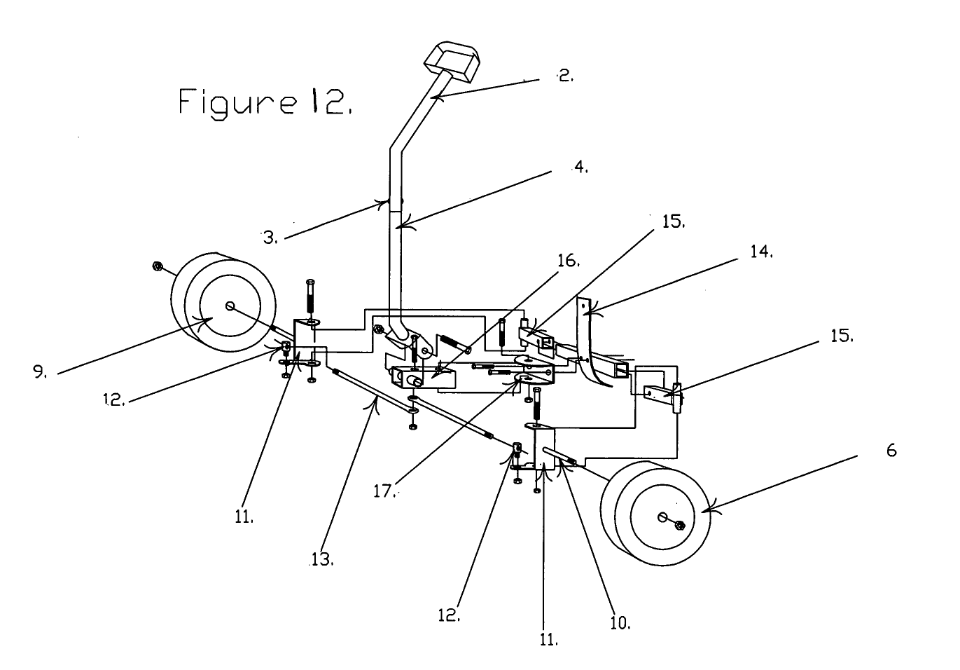

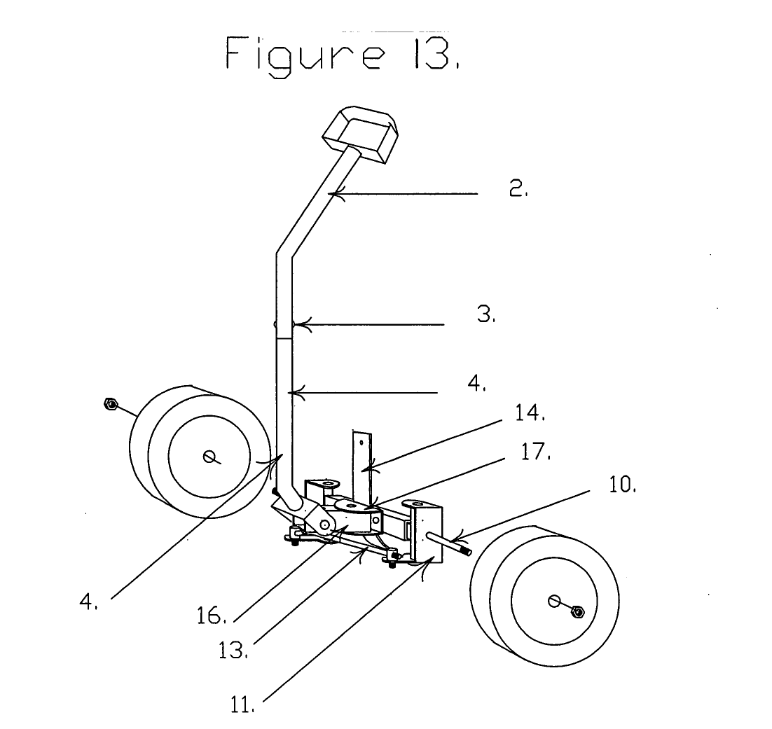

In FIG. 12 and FIG. 13 a particularly useful embodiment is shown where a front steering assembly having top handle assembly 2, is held together with bottom handle 4, by connector 3. The handle assembly is attached to steering neck 16 by a bolt combination or some functionally equivalent means as known in the art. Neck assembly 16 is connected to body pivot plate 17 by a bolt and nut combination or some other suitable means. Preferably, pivot plate 17 is secured about device 10 as it is bolted through the outer body of receptacle 100 (not shown), through front support 15, and finally into inner steel support 14. Front spindle assembly 11, in combination with axle spindle 10, is attached to the front spindle support 15 with a bolt and nut. Tie rods 13 are attached to steering neck 16 with a bolt and nut; the other end of each is connected to threaded pivot bolt 12, which is secured with a nut to front spindle assembly 11. Finally, tires 6 are secured about rims 9, which are placed front spindles 10 and secured by a bolt, pin, or any common securing mechanism as known in the art. The front steering assembly as depicted in FIG. 12 and FIG. 13, when used in combination with the insulated receptacle, provides for benefits not currently available with any known insulated storage receptacles. The steering mechanism, provides its user with an extreme mechanical advantage, and as such, a user can turn device 10 about a very small radius regardless of whether device 10 is of a relatively large or small mass. Moreover, when this steering assembly is used in conjunction with a mechanical propulsion means (such as a motor), the user is provided a high level of control with respect to precise steering. Obviously, the precise steering afforded here becomes increasingly important as the mass of the cargo contained within receptacle 100 increases. Summarily, the steering assembly allows for precise steering, largely independent of mass, that requires very little manual effort.

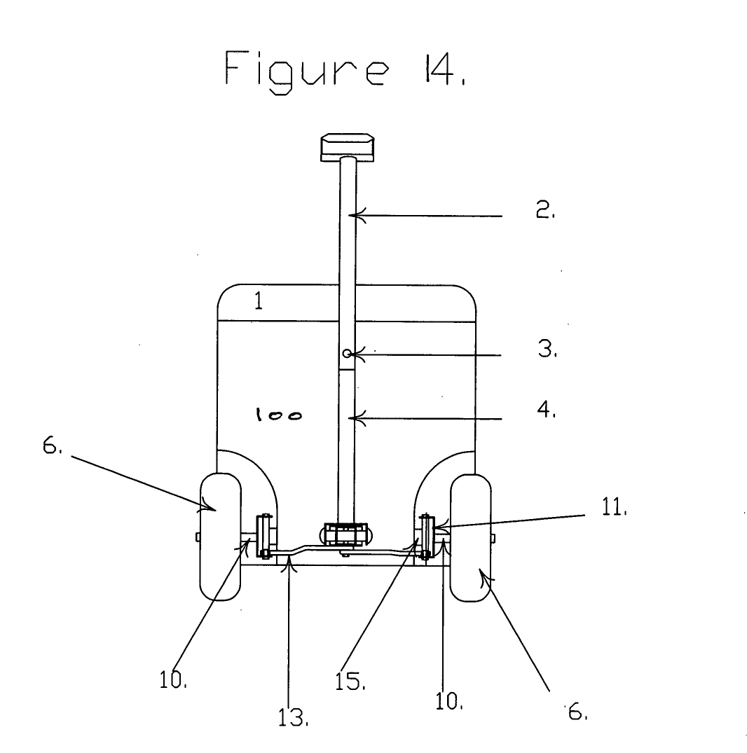

FIG. 14 shows a front view of the alternative embodiment having said front steering assembly. As shown, the two piece handle assembly of 2 and 4 is secured by connector 3. Connector 3 controls the steering of device 10 through the pushing or pulling of tie rods 13, which turns spindle assembly 10, which pivots on spindle support bracket 15, which in turn redirects tires 6, allowing the device 10 to be precisely steered.

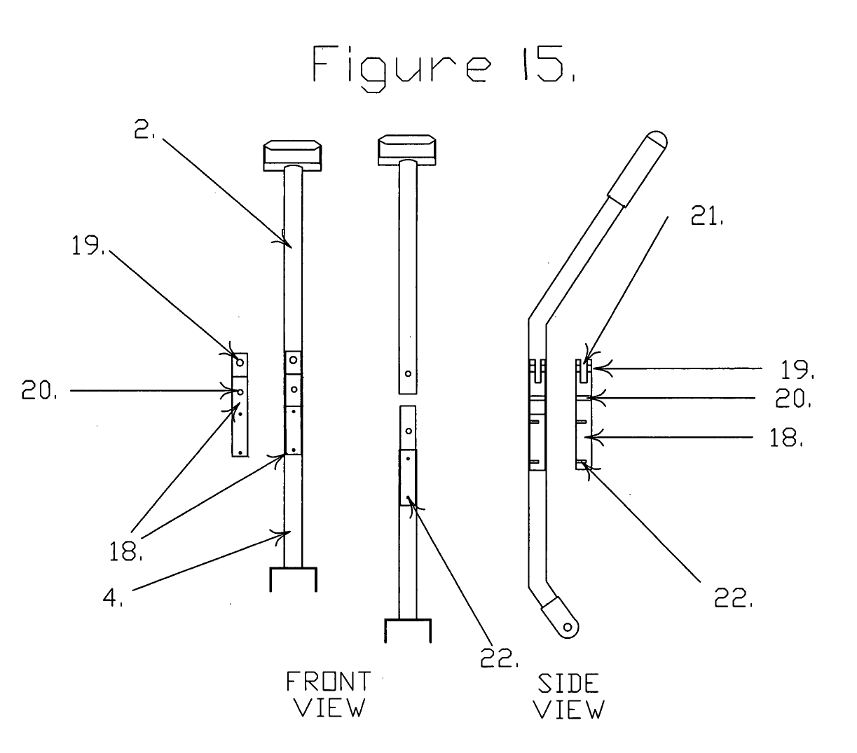

FIG. 15 depicts the front view of an embodiment where the handle assembly is formed by the combination of upper handle portion 2 and lower handle portion 4, each connected by metal connector 18. Metal connector 18 is secured to the bottom of handle 4 by a securing means, such as screws or pins, placed into holes 22. Top handle assembly 2 is attached to lower handle 4 by sliding the top assembly 2 onto metal connector 18 and then secured by a pin through hole 20. Again referring to FIG. 5, the side view shows how connector 18 attaches to a motorized insulated receptacle by sliding connector 18 into a flat trailer hitch whereby the flat trailer hitch slides into slot 21 and is then secured to the trailer hitch by a pin through hole 20.

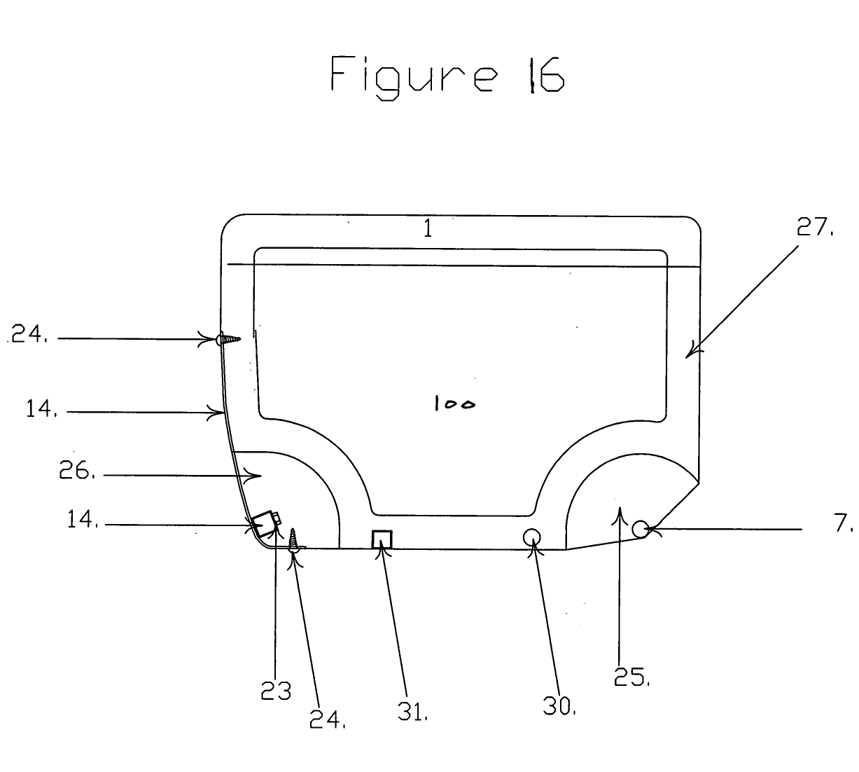

Referring to FIG. 16, front metal support 14 is secured to the outer wall of receptacle 100 by screws 24. When device 10 is in motion, the tires turn within wheel wells 25 and 26. Also shown is the foot peg support assembly 31 and drain aperture 30. The front spindle assemblies connect to the front metal support by their insertion into tube 14, which is part of the front metal support assembly.

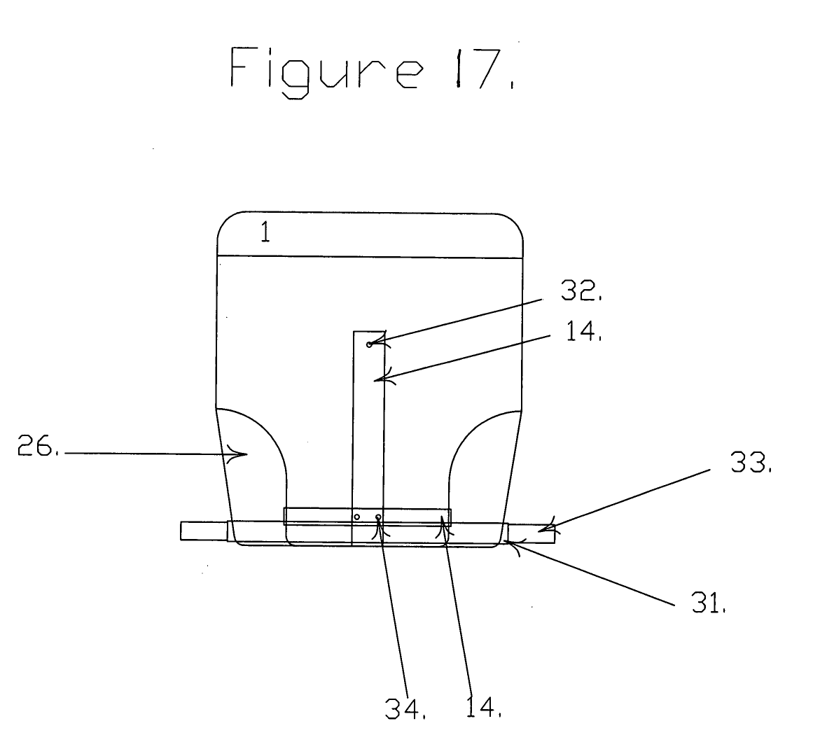

In FIG. 17 a cross section arrangement of particular components of device 10 is shown. Particularly, front support and spindle support assembly 14, secured to receptacle 100 through screws 32 is shown. The front body pivot plate secures to the inner support bracket 14 by bolts through 34, which also secure the front spindle support assemblies 15. Foot pegs 133 are seen extending from foot peg support tube 31, whereby pegs 133 may be spring loaded by an elastic cord allowing them to be retracted easily into tube 31. Such an arrangement makes for efficient use of device 10 as a rider may quickly and easily manipulate pegs 33 between an extended position during use and retracted position during non-use.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A propelled food and beverage receptacle comprising:
an insulated receptacle;
a motor engaged with a drive mechanism and further configured to adequately propel said insulated receptacle;
said drive mechanism engaged with said motor whereby operation of said motor actuates said drive mechanism;
at least three wheels, at least one of which being engaged with said drive mechanism and in mechanical communication with said motor via said drive mechanism;
a breaking means in communication with at lest one wheel and configured to provide speed reduction of said insulated receptacle;
a steering means in combination with at least one wheel and positioned so that said steering means is easily manipulated by a user of said insulated receptacle.

2. The propelled food and beverage receptacle of claim 1 wherein said insulated receptacle is configured to sufficiently support a user resting thereupon.

3. The propelled food and beverage receptacle of claim 1 further comprising a foot peg extending from said insulated receptacle and configured to provide support for a user of said receptacle.

4. The propelled food and beverage receptacle of claim 1, where said motor is substantially powered by gasoline.

5. The propelled food and beverage receptacle of claim 1, where said motor is substantially powered by electricity.

6. The propelled food and beverage receptacle of claim 1 further comprising a throttle mechanism configured to provide differential speed of said receptacle.

7. The propelled food and beverage receptacle of claim 1 where said steering means may be collapsed or angled for ease of driving or towing.

8. The propelled food and beverage receptacle of claim 1 further comprising a first attachment point where said insulated receptacle may receive a towing vehicle and a second attachment point where said insulated receptacle may receive a vehicle to be towed.

9. The propelled food and beverage receptacle of claim 1 wherein said receptacle has a first and second front wheel, each positioned about the front portion of said receptacle and said first and second front wheel are in mechanical communication with said steering means and a first and second rear wheel, each positioned about the rear of said receptacle and at least one of said rear wheels is engaged with said drive mechanism.

10. The propelled food and beverage receptacle of claim 1 wherein said steering means is comprised of a handle attached to a pivot point and thereby secured to a front portion of said receptacle, said fixed to a first and second tie rod extending therefrom where turning of said handle induces lateral adjustment of said first and second tie rods.
